(19) United States
(12) Patent Application Publication
(10) Pub. No.: US 2011/0223895 A1
(43) Pub. Date: Sep. 15, 2011

(54) Mobile Processor System to Incentivize Loitering

(76) Inventors: Donald Cloyce Wagda, Palo Alto, CA (US); Matthew Carl Lawyer, San Francisco, CA (US)

(21) Appl. No.: 12/719,865

(22) Filed: Mar. 9, 2010

(51) Int. Cl. H04M 3/493

(52) U.S. Cl. 455/414.2

(57) ABSTRACT

Apparatus and associated methods involve a system to monitor actual loitering times of a mobile communication device carried by an individual within a predetermined region, and provide rewards to the individual when the actual loitering times meet predetermined criteria.

### TECHNICAL FIELD

Various embodiments relate generally to methods and apparatus involving wireless communications with portable devices, and particular embodiments may involve promotional communications with content based on time spent in a specified location.

### BACKGROUND

In some retail environments, loitering may be often considered to have significant negative connotations. In a busy restaurant, for example, customers who loiter at a table long after a meal may consume valuable seating space and resources without generating additional revenue. Among other issues, loitering may consume retail resources, such as nonproductive use of the time of a salesperson, for example. From the perspective of some retailers, revenue may be maximized when loitering is kept to a minimum in order to maximize capacity to perform more transactions.

### SUMMARY

Apparatus and associated methods involve a system to monitor actual loitering times of a mobile communication device carried by an individual within a predetermined region, and provide rewards to the individual when the actual loitering times meet predetermined criteria.

Various embodiments may achieve one or more advantages. For example, some embodiments may advantageously incentivize customers to visit an establishment one or more times, the duration of each visit lasting for at least one predetermined duration.

Some implementations may mitigate attempts to obtain rewards without the customer physically remaining within the target region, for example, by withholding incentive rewards upon detecting insufficient movement below a required threshold.

The details of various embodiments are set forth in the accompanying drawings and the description below. Other features and advantages will be apparent from the description and drawings, and from the claims.

### BRIEF DESCRIPTION OF THE DRAWINGS

FIGS. 1A-1B are a schematic diagram of an exemplary process flow for a system in which rewards may be earned by maintaining a portable communication device (PCD) within a predetermined region for at least a predetermined time duration.

FIG. 2 shows a block diagram of an exemplary server with a loitering engine.

FIG. 3 shows exemplary data structures for the records associated with participation in the incentive system.

FIG. 4 shows exemplary screenshots for a PCD displaying an exemplary offer message to a user.

FIG. 5 shows a flowchart of an exemplary process for a user to operate a PCD to receive a reward from the incentive system.

FIG. 6 shows a flowchart of an exemplary process for operating an incentive system.

FIG. 7 shows exemplary process flow sequences for operating an incentive system.

FIG. 8 shows an exemplary retail client display that includes a dashboard control.

FIG. 9 shows an exemplary PCD client display that includes a dashboard control.

FIG. 10 depicts an exemplary map with varying duration requirements for multiple regions.

Like reference symbols in the various drawings indicate like elements.

### DETAILED DESCRIPTION OF ILLUSTRATIVE EMBODIMENTS

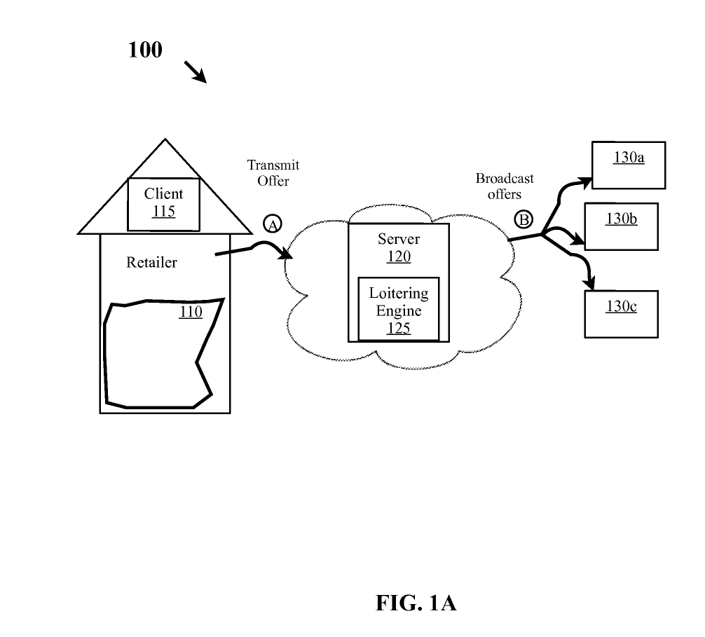

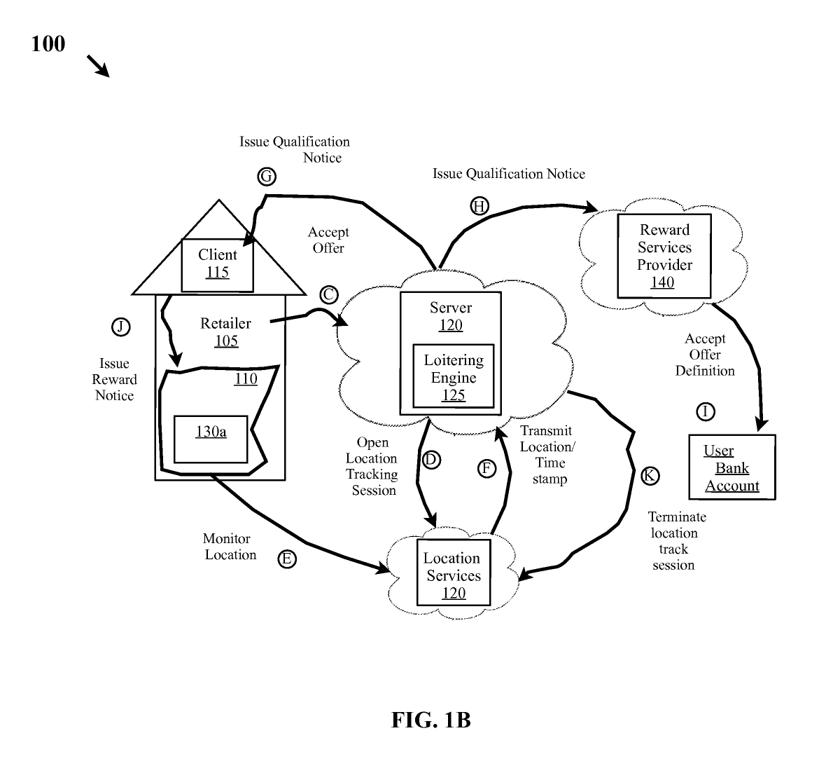

FIGS. 1A-1B are a schematic diagram of an exemplary process flow for a system in which rewards may be earned by maintaining a portable communication device within a predetermined region for at least a predetermined time duration. In the illustrated example, a system 100 contemplates a process flow in which a retailer transmits an electronic message to define an incentive offer. Specifically, the message associates location and duration criteria with reward information. A host server may receive the electronic message from the retailer, and cause messages with information about the incentive offer to be broadcast. The broadcast messages may be received by a number of portable communication devices (PCDs). A PCD that receives the broadcast message may display information about the incentive offer to a user, who may accept the offer. Upon verification that the user maintains the PCD at one or more locations that satisfy the location criteria for at least the corresponding time duration criteria, then the user may receive the associated reward.

The exemplary process flow 100 may be understood as including a number of operations. For purposes of clarity in explanation, a particular exemplary set of operations are described with reference to FIGS. 1A-1B. However, the sequence and arrangement of the described operations and apparatus are by way of example, and other embodiments are not limited to the express sequence or arrangement of the operations as described in this example.

As depicted, the flow 100 includes a retail store 105 with a predetermined region 110. In an illustrative example, the retail store operator wishes to incentivize PCD users to be in the region 110 for at least a predetermined length of time. To achieve this objective, the retail store 105 includes a retail client computer 115 that electronically transmits an offer definition message (A) to a host service provider with a server 120. The server 120 includes a loitering engine 125 for processing the definition message (A). In some examples, the loitering engine 125 may parse the received definition message (A) to identify at least one region criterion, at least one duration criterion, and associated reward information. In the depicted example, the region criterion corresponds to the physical borders of the predetermined region 110 as defined within the retail store 105.

The server 120 electronically broadcasts an offer message (B) for receipt by a number of PCDs 130a,130b,130c. The PCDs 130a-130c may receive and process the broadcast offer message information for presentation to a user. The server 120 may broadcast information for more than one offer.

FIG. 1B illustrates an exemplary continuation of the process flow in the system 100. In FIG. 1B, the user of the PCD 130a has moved to a location within the predetermined region 110 as defined in the offer definition message (A). In response to the broadcast offer message (B), the user makes an input to cause the PCD 130a to transmit an electronic message (C) to accept the offer. In another embodiment, the electronic message (C) to accept the offer may be received and processed by the retailer using the retail client 115.

In response to the accepted offer, the flow includes the server 120 sending an electronic message (D) to a location services module 135. The message (D) instructs the location services module 135 to open a location tracking session. During the location tracking session, the location services module 135 receives location information (E) about the PCD 130a. The location services module 135 transmits an electronic message (F) that repeatedly conveys updated location information (E) to the server 120 for processing by the loitering engine 125. In the depicted example, the electronic message (F) includes both location and associated time stamp information. In some embodiments, the electronic message (F) may convey location information to which the loitering engine 125 associates time stamp information when the location information is received.

The loitering engine 125 processes the location and associated time stamp information to determine whether the PCD 130a satisfies the criteria defined by the offer message (A). For example, the loitering engine 125 is configured to determine whether the received location information indicates that the PCD 130a remains within the region 110 for at least the duration criteria associated with the offer. The duration within the region 110 is monitored from the earliest time stamped time, after acceptance of the offer, at which the PCD 130a was first determined to be within the region 110. As used herein, the duration criteria for loitering may understood to refer to at least about 1 minute, such as, for example, at least about 1.5, 2, 2.5, 3, 4, 5, 6, 7, 8, 9, 10, 12, 14, 15, 20, 25, 30, 35, 40, 45, 50, or at least about 55 minutes, or at least about 1, 1.25, 1.5, 1.75, 2, 2.25, 2.5, 2.75, 3, 4, 5, 6, 7, 8, 9, 10, 11, 12, 14, 15, 16, 18, 24, 28, 30, 32, 36, 40, 44, 48, 50, 55, 60, 65, 70, or at least about 72 hours, or at least about 3.5, 4, 5, or at least about 6 days, or at least about 1, 2, 3, or at least about 4 weeks, or at least about 1, 2, 3, 4, 5, 6, 7, 8, 9, 10, 11, or at least about 12 months, or any of these in a linear combination.

If the loitering engine 125 determines that the position of the PCD 130a remains within the region 110 for the duration criteria and any other requirements, then the loitering engine 125 issues a qualification notice message (G) to the retailer client 115. In some embodiments, the loitering engine 125 will not issue the qualification notice message (G) until information from the location services module 135 confirms that the location of the PCD 130a satisfies any threshold criteria for sufficient distance and/or time outside of the predetermined region 110.

In the depicted example, the loitering engine 125 further issues a qualification notice message (H) to the reward service provider 140. If, as in the depicted example, the reward involves a direct payment of funds to the user of the PCD 130a, then the flow 100 further includes an electronic transfer of funds (I) to distribute the reward directly into the user bank account 150. In other embodiments, the reward service provider 140 may be closely related to the retailer 105, or the retailer 105 may be the reward service provider, whereby the qualification notice message (H) is received by the retailer client 115.

Finally, the retailer client 115 of this example issues a reward notice (J) as an electronic notification message to be received by the PCD 130a. The loitering engine 125 further sends an electronic message (K) to the location services module 135 with an instruction to terminate the location tracking session associated with the accepted offer. In response, the location services module 135 may cease to transmit location-containing messages (F) to the server 120.

In the example depicted in FIGS. 1A-1B, the server 120, retail client 115, and the PCD 130a may be processor-based devices configured to perform operations that include receiving an input signal, processing information in response to the received input signal, and providing output signals or actions based on the processed information. Input or output signals may be, for example, in the form of electronically encoded messages transmitted or received via wireless links. In various implementations, the processor-based devices may process information by executing modules of instructions, which may be stored as information in a data store (e.g., register, volatile or non-volatile memory). The operations may be performed, for example, by one or more processors either alone or in combination with other analog and/or digital circuitry. Some embodiments may process information using programmable devices (e.g., PLDs, gate arrays, or application specific circuits). Output actions or signals may be processed using, for example, input/output devices, communication interface hardware (e.g., transceivers, antennae, infrared communication ports) and/or signal processing circuitry.

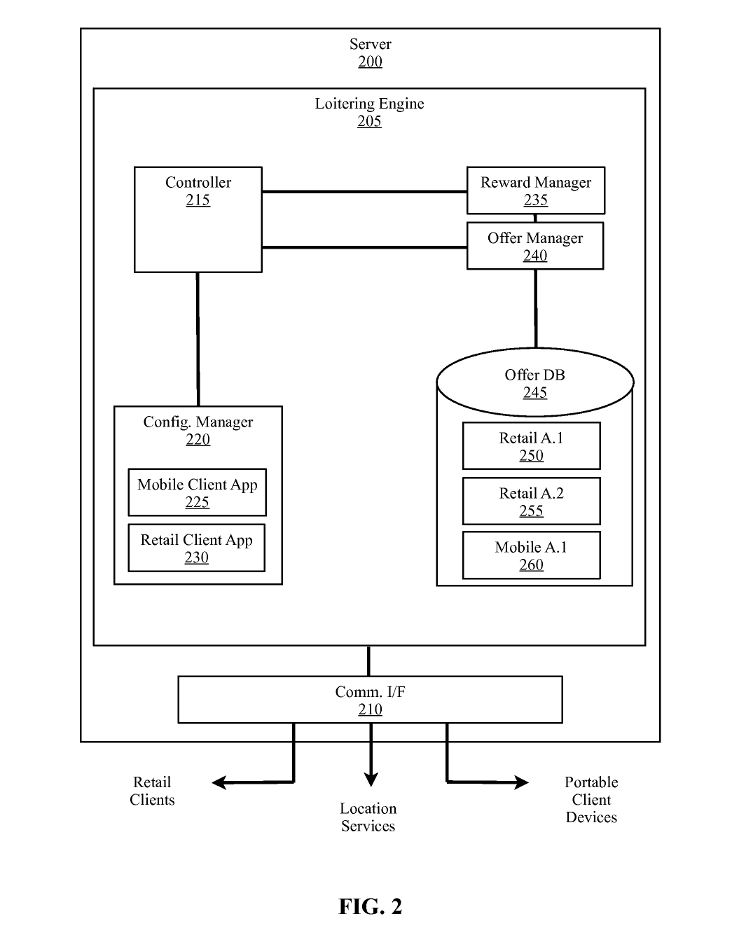

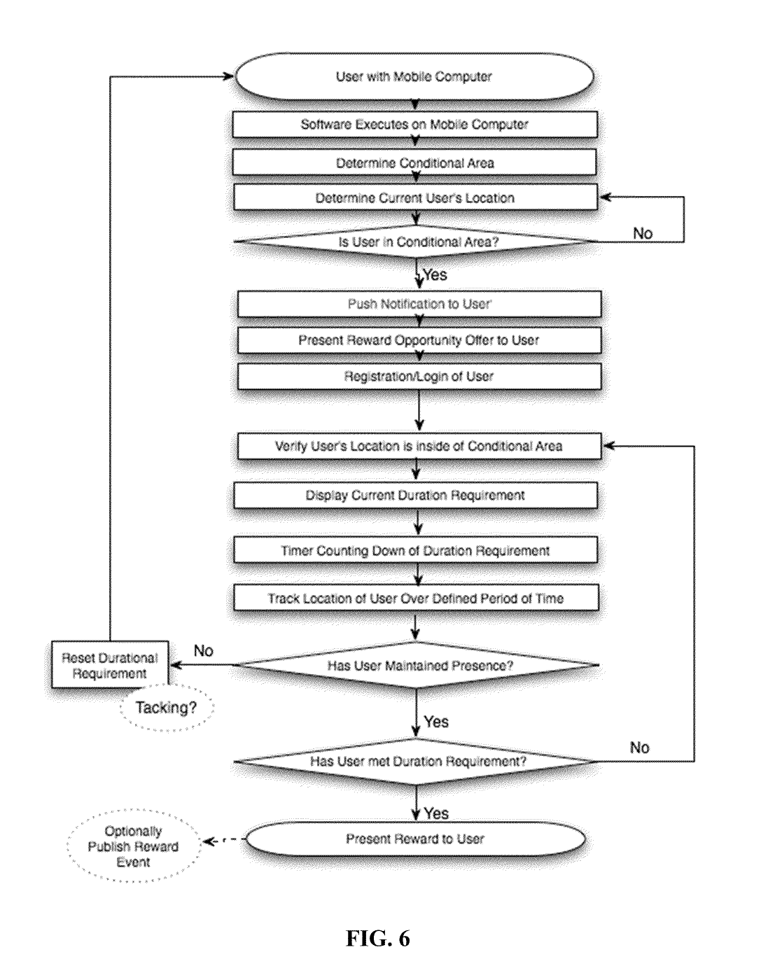

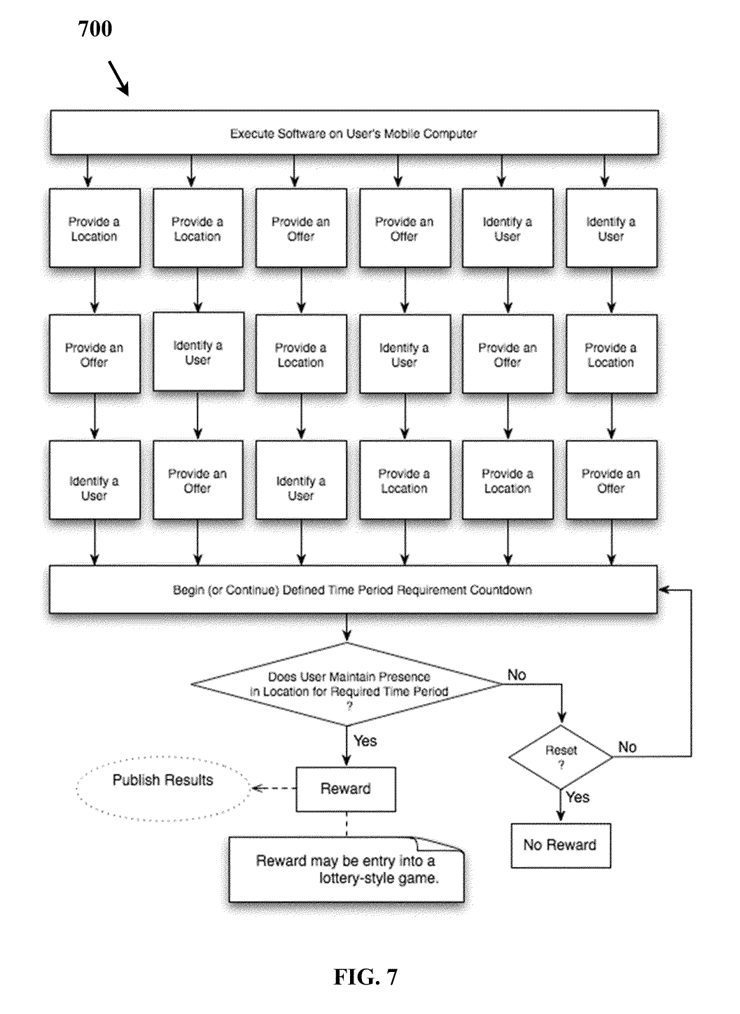

FIG. 2 shows a block diagram of an exemplary server with a loitering engine. The server 200 includes a loitering engine 205 and a communication interface 210 for communications with other systems. The loitering engine 205 performs operations to implement processes to incentivize PCD users to go to a specified region and remain within that region for at least a predetermined threshold period of time. The operations performed by various embodiments of the loitering engine 205 will be described in further detail with reference, for example, to FIGS. 6-7.

With reference to the example of FIG. 1B, the server communication interface 210 may be configured to send and/or receive information in electronically encodes messages to or from the retail client 115, a client running on the PCD 130a, the location services module 135, and the reward service provider 140. For example, the communication interface 210 may transmit application programs to execute the PCD client on the PCD 130a in response to receiving a request to download the applications. The communication interface 210 may communicate directly or indirectly with such other devices using communication channels that may involve wired, wireless, and/or optical communication links, such as via an intranet, the internet and/or telecommunication infrastructure, for example.

In the depicted example, the loitering engine 205 includes a controller 215 that supervises and controls the processing of mobile client accounts associated with registered PCDs 130a-130c, registered retailers 105 associated with retail clients 115, and information relating to offers, acceptances, locations, durations, qualifications, and reward processing.

The controller 215 interacts with a configuration manager 220, which may include a processor programmed with instructions that, when executed by the processor, perform operations to provide configuration information to clients, such as the retail client 115 and the PCD clients 130a-130c. Retail clients and PCDs may register and download the appropriate application programs to participate in the incentive system 100.

For example, the server 200 may receive a request from a portable communication device (e.g., PCDs 130a-130c) to register to accept an offer in the incentive system 100. Upon receipt of the request, the controller 215 may route the request to the configuration manager 220 for processing. Since the request pertains to a user, the configuration manager may retrieve a set of instructions for a mobile client application program 225 from a data store of the configuration manager 220. The loitering engine 205 may then convey the mobile application program 225 to the communication interface 210 for transmission to the requesting PCD 130a-130c for storage in its data store and execution on its processor. In various embodiments, the application program 225 may, when executed on a processor, cause the PCD client 130a-130c to display a user interface on a display device.

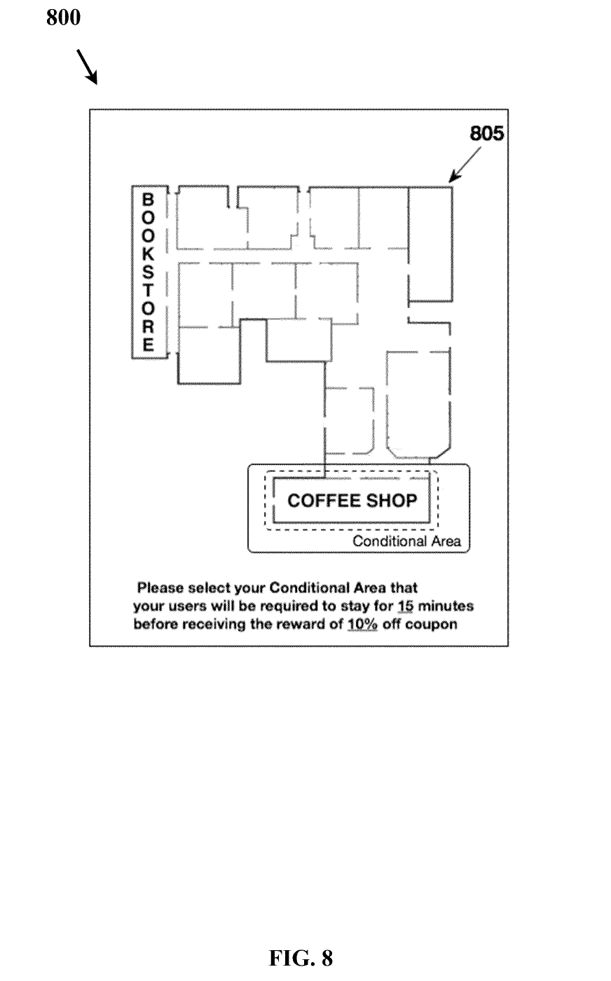

For another example, the server 200 may receive a request from a retailer (e.g., retailer 105) to register to publish an offer in the incentive system 100. Upon receipt of an electronic message that includes the request, the controller 215 may route the request message to the configuration manager 220 for processing. Since the request pertains to a retailer, the configuration manager may retrieve a set of instructions for a retail client application program 230 from a data store of the configuration manager 220. The loitering engine 205 may then convey the application program 230 to the communication interface 210 for transmission to the requesting retail client 115 for storage in its data store and execution on its processor. In various embodiments, the application program 230 may, when executed on a processor, cause the retail client 115 to display a graphical user interface (GUI) on a display device. For example, the GUI may include a dashboard control, an example of which will be described with reference to FIG. 8.

In some implementations, the mobile application program 225 and/or the retail application program 230 may be arranged to operate as a thin client in which content relating to the incentive reward system 100 may be delivered from a remote server, such as the server 200, to the client for display. The mobile or retail application programs 225, 230 may collect account information and other identifying information (e.g., types of available location determining services) about the retailer or the users of the PCDs 130a-130c.

In the depicted example, the controller 215 operates with a reward manager 235 and an offer manager 240 to process offers and manage reward operations. When a retailer submits a request to establish an offer, the loitering engine 205 receives the request, and the controller 215 routes the request to the offer manager 240.

The offer manager 240 may verify the request meets certain predetermined criteria. For example, the offer manager 240 may initially perform operations to verify that the request includes valid region (e.g., location, size, or tolerance zones) and offer parameters (e.g., duration of offer), and/or that adequate systems are available to track the location of a PCD. Tolerance zones may be predetermined regions around the borders of a desired target region, or where location determination services may not provide adequate resolution to determine whether the tracked PCD is in or out of the predetermined region. In some cases, the offer may be limited to certain technologies (e.g., 3G networks, Wi-Fi), and the offer manager 240 may check for valid coverage, for example.

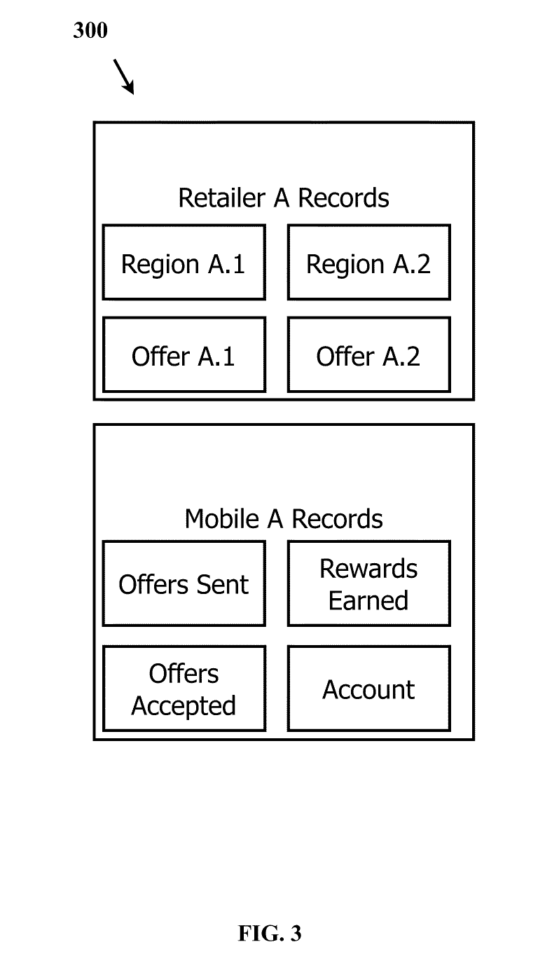

The offer manager 240 may further parse an offer request into its constituent information components for storage as a record in an offer database 245. In the depicted example, the database 245 contains records 250, 255 containing information associated with two retailers, and one record 260 containing information associated with a mobile user, or PCD. Exemplary data structures for the records 250-260 are described in further detail with reference to FIG. 3.

The offer manager 240 may be configured to execute instructions to perform operations to publish an offer according to a predetermined schedule, or to targeted PCDs. In some implementations, an offer campaign or distribution list may select PCDs or other receiving devices that are not registered in the incentive system 100. In some offer campaigns, at least some of the targeted PCDs may be selected based on criteria associated with a mobile record, such as the record 260, stored in the offer database 245. The offer manager 240 may publish the offer to any number of PCDs in accordance with the broadcast offer message (B) described with reference to FIG. 1A.

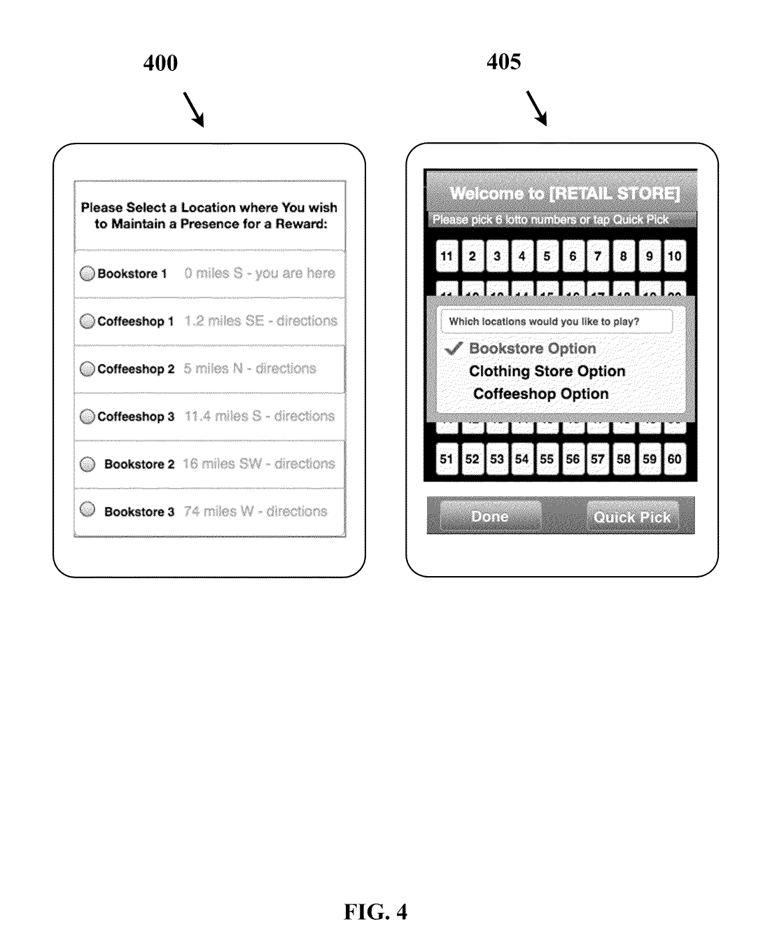

Upon receiving the offer message, the PCD may display one or more offers to the user. Examples of a PCD display showing an exemplary offer message depicted in FIG. 4. If the user selects and accepts one of the offers, the PCD transmits a message back to the server 200 in accordance with the message (C) described with reference to FIG. 1B.

The controller 215 may route the acceptance information, including identifying information about the PCD or user and identifying information about the selected offer to the offer manager 240. As an example, the offer acceptance message may indicate that the PCD associated with the record 260 has accepted the offer parameters associated with the record 255. Accordingly, the offer manager may update the record 260 with a status information that indicates that the offer for the record 255 should be associated with that PCD.

The offer manager 240 may next cause a message to be generated and sent to the location services module, in accordance with the message (D) to initiate monitoring of the location of, for example, the PCD 135a relative to the predetermined region 110. The offer manager 240 may simultaneously process the operations for any number of PCDs and any number of offers. In some embodiments, this may be implemented with multiple processors, processing threads, cores, or other suitable techniques for processing multiple operations, which may be at different stages, and running substantially concurrently.

The controller 215 may route to the offer manager 240 any location information received from the location services module 135 in accordance with the message (F). In some embodiments the location messages (F) may include timestamp information that the offer manager 240 may parse and store in a data store. The offer manager may, for example, perform a post-processing operation to scan for durations of time when the location criteria are met to determine whether the duration criteria are met. Post processing may be performed on a scheduled basis whether needed or not. In some embodiments, post-processing review of location data may be performed during periods of available processor bandwidth, for example.

In some embodiments, the offer manager 240 may monitor time information using a timer module (not shown) that may record a time when the PCD enters the predetermined region 110, and determine whether the required a countdown time set to the predetermined duration has expired before any location information indicates that the PCD is not within the predetermined region.

In some embodiments, the offer manager 240 may check for further criteria after the duration within a location criteria have been satisfied. For example, the offer manager 240 may continue to monitor location to verify when the PCD is moved to a location substantially outside of the predetermined region 110. As another example, a second PCD user may be required to loiter in the specified region for the specified duration.

In some embodiments, the offer manager 240 may monitor how long or whether the PCD location remains within the predetermined region 110 after satisfying the criteria for the minimum duration. According to a predetermined formula, the reward may diminish or be eliminated if the duration within the region 110 exceeds certain predetermined thresholds.

In some examples, the offer manager 240 may dynamically adjust one or more criteria associated with the offer in response to inputs associated with measured signals relating to behaviors of the PCD or its user. For example, some offer managers 240 may reduce or excuse duration requirements if more than a threshold number of customers enter the retail store or, if the retailer determines to set a loitering flag signal that causes the offer manager to reduce the duration requirement for at least some of the PCDs. In some implementations, partially completed durations may be completed over one or more visits to the retail store and may be aggregated to satisfy the durational requirement, which may advantageously encourage more frequent, shorter visits.

In some embodiments that include an offer manager 240 with dynamic duration criteria, the durational criteria may be extended, for example, if the offer manager 240 can detect no change in PCD location for more than a threshold duration. Extended periods of lack of movement may indicate that the user is not carrying the PCD. In some examples, the PCD user may have the ability to generate a signal to temporarily suspend the location monitoring by making a user input via the mobile client application program that was downloaded to the PCD client, or upon request of the retailer using the retail client 115.

In some embodiments that include an offer manager 240 with dynamic duration criteria, the durational criteria may be shortened, for example, in response to the user making a purchase from the retailer. As an example, the offer manager 240 may receive a sales notification message generated by the retail client 115. In an illustrative example, the sales notification message may be associated with a particular offer of the retailer and/or with the PCD user's account information in the offer database. In response to the sales notification message, the loitering engine may perform operations to adjust the durational requirement for the user as it pertains to that offer. In some examples, the amplitude of the adjustment to the durational requirement may be a function of a parameter in the sales notification message. In some examples, the loitering engine may reduce the durational requirement according to a predetermined function, which function may be determined based on one or more parameters included in the sales notification message. For example, some predetermined functions may adjust the durational requirement in accordance with a reduction schedule or formula. By way of example and not limitation, various embodiments of a reduction schedule or formula may be based on information about a number of items purchased by the PCD user, the particular types of items bought, and/or a purchase price paid for any items.

Upon determining that the PCD has met all the duration criteria in the required location, and any required supplemental criteria, the offer manager 240 may transfer processing control for the mobile record and selected offer to the reward manager 235. The reward manager 235 may handle operations to cause notification of a qualified PCD to be delivered to the client server 115 (in accordance with the message (G)) and/or to the reward service provider (in accordance with the message (H)). The reward manager 235 may coordinate the communication and/or delivery of the reward for the benefit of the qualified user.

FIG. 3 shows exemplary data structures for the records associated with participation in the incentive system. In this example, a data structure 300 includes records for one exemplary retailer (“Retailer A records”) and one exemplary user (“Mobile A records”).

The Retailer A may establish one or more physical regions as criteria for one or more offers for the incentive system. In addition to general account information in the Retailer record, this example depicts two defined geographic region definitions (Region A.1 and Region A.2) and two offer definitions (Offer A.1 and Offer A.2). Each offer definition may specify one or a combination of both of the defined regions as the location criteria. Each offer definition may further specify the durational requirement, the reward structure, and any supplemental requirements or adjustments to the offer. As the retailer establishes new offers in the future, such future offers can simply refer to the previously defined location records.

In this example, a “Mobile A Records” stores information about a user of the incentive system. The stored information associated with the user may include a record of offers made to the user (“Offers Sent”), offers accepted by the user (“Offers Accepted”), and rewards earned (“Rewards Earned”). These records may be used by the configuration manager 220, the reward manager 235, and the offer manager 240 to operate various embodiments of the incentive system as described herein. In some embodiments, information stored in the loitering engine may further include, for example, rewards received by the user (not shown).

FIG. 4 shows exemplary screenshots for a PCD displaying an exemplary offer message to a user. The display of these screenshots may be generated by the PCD client executing instructions that include the mobile client application program 225 described with reference to FIG. 2, for example.

Screenshot 400 presents to the user a list of closest locations with available offers in an incentive system. The list includes a distance estimate relative to the current location of the PCD. Each item in the list includes a description of the location offering the incentive, a distance from current location, and a hyperlink to access directions to the location.

Screenshot 405 presents to the user two layers of information. The top layer presents a list of three available zones within a retail store that is participating in an incentive system. In this example, the three zones in the retail store include a bookstore, a clothing store, and a coffee shop. In some examples, these may be three independent businesses in close proximity, such as in a shopping mall. Associated with each option may be, for example, different location and duration criteria, and different rewards. For example, each option may require that the user loiter in the corresponding portion of the retail store in order to satisfy the duration criteria. As another illustrative example, the reward for the bookstore may be a discount on a paperback or a free newspaper, while the reward for the coffee shop may be a pastry or a cup of coffee.

On the second layer of the screenshot 405, a lottery-style game with selectable numbers is displayed. Upon making a selection of the top layer, the user may be entered into the lottery-style game as at least part of the reward. As one way of gaining entry into the lottery-style game, the user would have to satisfy the durational stay requirement for the location selected in the top layer of the screenshot 405.

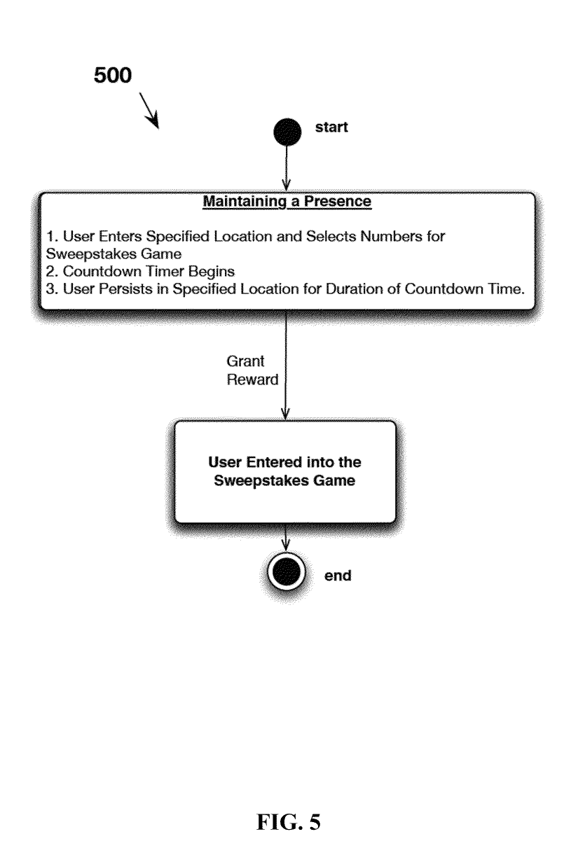

FIG. 5 shows a flowchart of an exemplary process for a user to operate a PCD to receive a reward from the incentive system. For entry into a lottery-style sweepstakes or game, such as the lottery-style game depicted in the screenshot 405, a PCD operated by a user may perform an exemplary set of operations shown in the flowchart 500.

In a first set of steps, the PCD may perform operations to coordinate steps for the user to maintain a presence in accordance with an offer. The operations include the user inputting (or selecting) a specified location and making an input to select numbers for a sweepstakes-style game. In response, the PCD client automatically begins a countdown timer, for example, which may be based on a hardware timer, software timer, or a combination thereof. To satisfy the loitering time duration requirements, the user persists in the specified location. Upon successfully maintaining presence for at least the specified duration, the loitering incentive system grants to the user a reward according to the offer. In the depicted figure, the reward involves being entered into a sweepstakes game.

By way of example and not limitation, embodiments of a lottery-style sweepstakes system may be adapted to interface with embodiments of a loitering incentive system. Embodiments of one lottery-style sweepstakes system that may be so adapted is described with reference to, for example, at least FIGS. 3-4 in U.S. Pat. No. 6,454,650, issued to K. Aronin and entitled “Free Remote Lottery System.” The entire disclosure of U.S. Pat. No. 6,454,650 is incorporated herein by reference.

FIG. 6 shows a flowchart of an exemplary process for operating an incentive system. In this example method 600, an incentive system, such as the system 100, may monitor locations of registered users who are carrying their PCDs in a predefined conditional area in which a retailer has established an incentive program. Upon detecting that a registered user carries their PCD into the predetermined conditional area, the offer manager of the loitering engine may send out a notification (e.g., push notification) to the PCD. The PCD presents the reward opportunity offer to the user. The user may make inputs to the PCD to login, register (if needed) and accept the offer with a return message to the incentive system.

Upon receiving the user's acceptance message, the incentive system operates as described herein to verify the user's location is inside of the conditional area. In this example, the PCD displays to the user the amount of time remaining to qualify for the reward. In some embodiments, the user may receive text messages, emails, warning indicators (e.g., audio, graphical, and/or tactile) that give an indication as to the remaining time to satisfy the duration requirement. Some embodiments may further present offers for reducing the amount of time, such as, for example, a percentage decrease in time duration requirement according to the value of purchases made.

The loitering engine continues to track the PCD location and time remaining. If the loitering engine determines that the user has maintained a presence to satisfy the location and duration requirements, a reward is presented to the user. In some embodiments, the reward may be published, for example, by an announcement, message on an Internet website, or on a visual display. In some embodiments, the reward may be displayed on a retailer's dashboard, examples of which are described with reference to FIG. 8, for example.

However, if the user has not maintained a presence, the durational requirement may be reset. If the user has not met the duration requirement, then the loitering engine continues to the step of verifying the user's location is inside the conditional area.

FIG. 7 shows exemplary process flow sequences for operating an incentive system. In this example 700, the method begins with the PCD executing software, such as the mobile client application program described with reference to FIG. 2. The incentive system operates by performing three steps, which may occur sequentially and in any order. One of the steps is to provide a location definition, such as region 110 of FIG. 1A. Another step is to identify a user of the PCD, which identifying information may be stored in a record in the offer database 245, for example. The third step is to provide an offer, which may be defined by a retailer, for example, and retrieved from the offer database 245.

Having established the user, the offer, and the location criteria, the method further includes monitoring a countdown of a defined time period. The loitering engine checks to verify that the user maintains a presence in the location for the required time period. If the user does maintain presence, then a reward is generated, which may include entry into a lottery-style game. If the user does not maintain presence throughout the required time period, then the system decides whether to reset the timer. If the timer is reset, no reward will be earned. If the system does not reset the timer (e.g., in accordance with terms of an agreement between the user and the retailer), then the countdown of the timer freezes until the user reenters the conditional area, at which time the countdown unfreezes and continues.

In some other implementations, some offers may be defined by the retailer so as to reset to the full durational requirement upon the incentive system detecting that the user has not maintained presence in the conditional area for the required duration. In some further implementations, the counter may reverse direction upon detecting that the PCD user has not maintained presence in the conditional area, whereby the durational requirement to satisfy the offer may increase in one or more increments based on the length of time the user has been out of the conditional area. For example, for every 10 minutes that the PCD user has not been detected within the conditional area, based on location services that may track the PCD, the remaining time to satisfy the durational requirement may be increased by one minute up to a predetermined limit, which may be the same or a predetermined fraction of the full original durational requirement.

FIG. 8 shows an exemplary retail client display that includes a dashboard control. In this example, the display 800 of the PCD includes a dashboard 805 with a graphical user interface (GUI). As depicted, the GUI displays an interactive online tool for the retailer to define a conditional area on a map of a target region. In this example, the dashboard 805 permits the retailer to specify a region by locating a dynamically sizable polygon over a map. The dashboard 805 further includes two text input fields that are both indicated with an underline in FIG. 8. A first text input field is provided to receive text input to specify a durational requirement that the retailer would like to specify for the offer. A second text input field is provided to receive text input to define a discount percentage for a coupon to be associated as a reward in the offer.

In further embodiments, the dashboard 805 may include additional screen displays (not shown) that may be sent for display to the display device of the PCD. In various examples, additional screen displays may include retailer input controls to allow a retailer to make inputs to select or define offer configurations. By way of example, and not limitation, user input controls in such a retail client dashboard may receive selection or definition information relating to (1) specific offerees (e.g., PCD users who have signed up to be on an email list), (2) durational requirements (e.g., ten minutes), (3) particular rewards offered (e.g., plush toy teddy bears), (4) conditional regions (e.g., a supermarket and its parking lot). In some embodiments, the dashboard may operate to display rewards actually earned. The retailer client may include instructions for monitoring the earned rewards display by comparing the earned rewards with a threshold level or range of expected rewards. The result of the comparison may be monitored to detect fraud, for example.

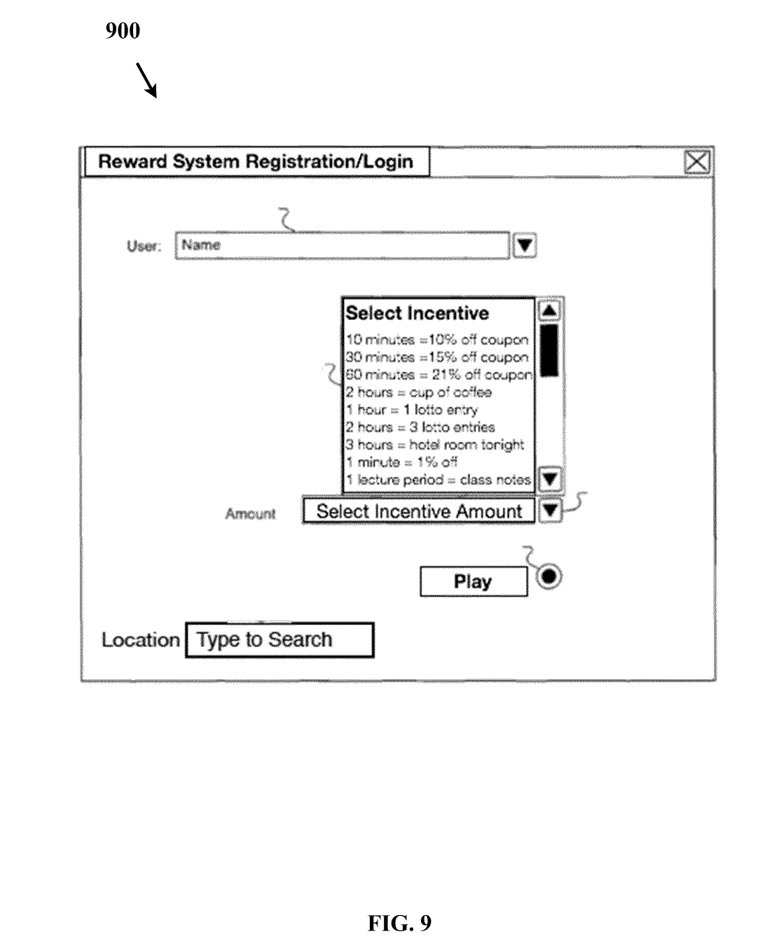

FIG. 9 shows an exemplary PCD client display that includes a dashboard control. In this example, the display 900 of the PCD depicts a dashboard with a graphical user interface (GUI). As depicted, the GUI displays an interactive tool for the PCD to accept an offer in a loitering incentive system. A first user input control permits the user to enter a registered name for purposes of logging in to the incentive system, for example. The user information will be communicated to the loitering engine for processing of the offer, whereby the loitering engine will store an association between the identifying information and an offer.

As a second exemplary user input control, the display 900 includes a drop down list box with predetermined options associated with a number of variations of an offer. Each entry in the drop down list box is a user selectable choice that represents a duration requirement and an associated incentive reward. The PCD user may select which combination of duration and reward to accept. In some examples, the user may be permitted to select more than one entry on the list, or all entries on the list.

A third input control displays a user selectable button that the user may activate. Upon activation, the PCD client may generate an electronic message to the loitering engine. The message may include information about the acceptance status, the user information, and the selected combination of duration and incentive.

A fourth input control displays a text input field in which a location may be entered and/or displayed. In some embodiments, the location input field may display a drop down list of available nearby locations with available offers. In some implementations, the user may be permitted to input a type of location (e.g., book store, coffee store, night club) of interest, and in response, the PCD client may perform a search and return with a display of a user selectable list of nearby locations that match the user input.

The PCD client display of FIG. 9 may, in some embodiments, be displayed on a desktop computer or a computer that is not regularly carried around by the user. For example, a user may login to a website on the Internet to register as a user and/or select and accept one or more offers to incentive loitering. Upon acceptance, the user may have a predetermined time period in which to satisfy the location and duration requirements of the offer.

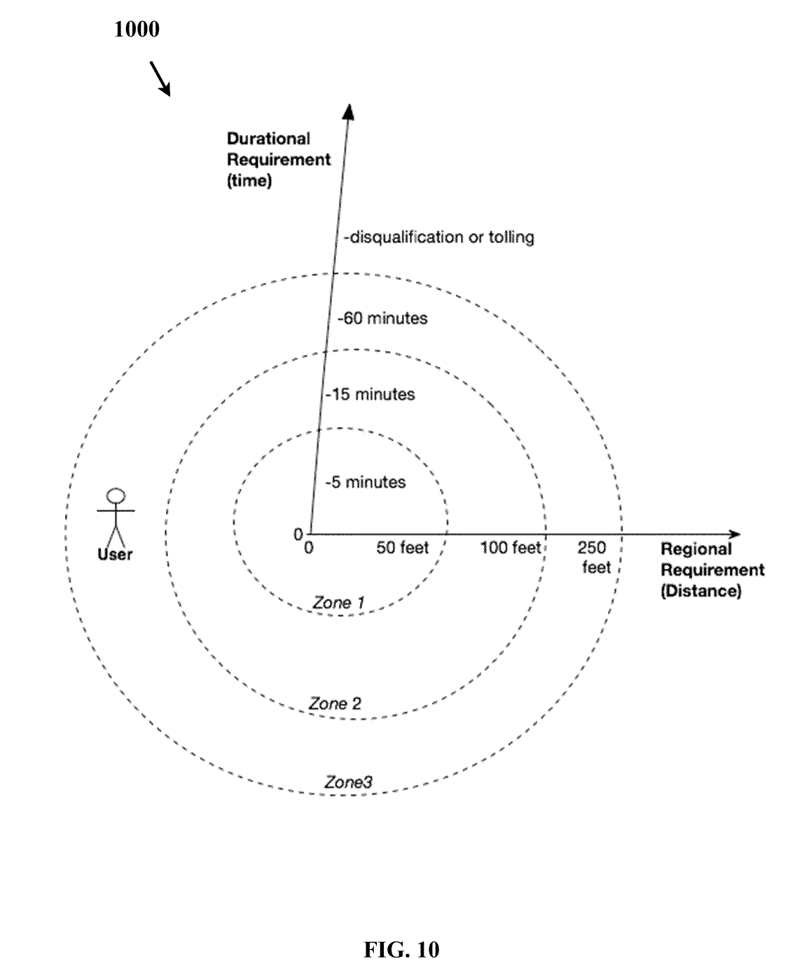

FIG. 10 depicts an exemplary map with varying duration requirements for multiple regions. In this example, an offer is represented with a location map 1000 with three enclosed zones labeled as “Zone1,” “Zone2,” and “Zone3.” This representation illustrates the structure of the offer as having different duration requirements as a function of the zone in which the PCD user is present. In Zone1, within a 50 foot radius of a central point, the duration requirement is set to 5 minutes. In Zone2, between a radius of 50 feet and 100 feet, the duration requirement is set to 15 minutes. In Zone3, between a radius of 100 feet and 250 feet, the duration requirement is set to 60 minutes. For distances beyond 250 feet from the central point, the duration requirement may be tolled or reset, as has been described herein.

In some implementations, the loitering engine may be configured to monitor the location of a PCD user as it traverses between Zone1, Zone2, and Zone3. The loitering engine may be further configured to credit the user with time toward the durational requirements based on time spent in each respective zone. For example, the loitering engine may credit the user while in zone2 at four times (60 minutes:15 minutes) the rate provided for zone3. The loitering engine may credit the user while in zone1 at three times (15 minutes:5 minutes) the rate provided for zone2. As an example, the user may earn the reward for spending at least 1 minute in zone1, 2 minutes in zone2, and 40 minutes in zone3.

Although the example of FIG. 10 defines concentrically circular zones, other embodiments are possible. In various embodiments, one or more zones of any practicable shape may be defined. For example, zone perimeters may be defined with edges defined according to a simple or complex combination of one or more closed polygons (e.g., rectangle, octagon, cross) and/or curved shapes (e.g., arc, oval, kidney bean, crescent). In one example, a zone may be defined to include, at least in part, an inner and an exterior boundary of a portion of a sidewalk around two sides of a building.

Although various embodiments have been described with reference to the figures, other embodiments are possible. For example, some or all elements of the server 120 may be located on the same computer or local computer network as the retail client 115. In some embodiments, some or all elements of the reward services module 140 and/or the location services module 135 may be located on the same computer or local computer network as the server 120. In some implementations, some of the communications may be transmitted and/or received among retail and/or PCD clients, for example in a peer-to-peer network.

In an exemplary embodiment, a PCD client, alone or in combination with a retail client, may include instructions for performing some or substantially all of the operations to implement an embodiment of the loitering engine.

In various embodiments, a PCD user may select a conditional area to which to travel in order to play a game. If the user successfully maintains a presence at the selected conditional area for a set time period, the user may receive a reward. As an example, a reward may be time-sensitive, such as a coupon with an expiration date, where the coupon is redeemable for a discount at the point of sale of an item (e.g., a book) or for a free cup of coffee. In some examples, the reward may include an entry in a lottery-style game or other game or contest.

As used herein, a PCD may include processor-based devices that include a user input interface, a data storage device, an output device to communicate offer information to the user, and a communication interface for sending and receiving electronic messages between the processor and the server. By way of example, and not limitation, the PCD may include a portable computer, netbook, notebook computer, tablet computer, smart phone, portable digital assistant, cellular phone, or other processor-based system. In various embodiments, the communication interface may be wireless and use optical, audio, and/or electromagnetic (e.g., radio frequency) communication techniques.

In some embodiments, the PCD may be configured with an application program (which may be referred to herein as an “app”) that includes a set of instructions which may be stored in the data storage device (which may be referred to hereinafter as “data store”) of the PCD. In an example, the communication interface (e.g., wireless transceiver module) of the PCD may receive an incentive offer broadcast message. The received message may be processed by the processor according to the app instructions as retrieved from the data store and executed by the processor.

In an embodiment a customer may download a free smartphone application called “LoiterBucks.” In this example, the customer taps to open the application, which informs her of participating establishments and provides optional maps and directions to merchants in her vicinity. The customer uses the application to find a participating clothing store. When the customer enters the store, the application and server automatically verify and create a record that the customer is present at the store by comparing the latitude and longitude of the store with the latitude and longitude of the smartphone (as estimated by the smartphone through GPS, cell tower triangulation, or other mobile-device location determining technique). In another example, the customer may “check-in” at the store by opening the application, tapping a button or interacting in some other way with the application. When any of the foregoing occurs, a timer begins to keep track of how long the customer is in the store. The application and the server check the location every so often (e.g., every two minutes) to determine that the customer is still in the store. When the customer achieves certain predetermined milestones of loitering as measured by this system, she may be credited with a reward accordingly.

In some implementations, a “loitering” reward could include money. In one embodiment, the reward may be redeemable upon presentation of identifying credentials to a sales clerk who has access to a retailer access terminal in the incentive system. In another embodiment, the customer may receive feedback that money will be electronically transferred to a bank or retail store charge account. In a particular example, the money payment may be credited to an outstanding bill of the customer. In yet another embodiment, a money reward may be automatically sent to the mailing address of the customer. In some examples, the customer may have the option to set up which mode of payment to receive cash rewards. In some embodiments, the incentive system may provide differentiated money payments, for example, based on the mode of payment that customers elect to accept.

In some embodiments, a loitering reward may be provided to the customer in the form of a gifts, gift certificates, money, a coupon, a coupon-book, a discount, free, discounted, or upgraded good or service, a rebate, a public acknowledgment, a service, an item of goods, a stock, a gift certificate, a bond, a lottery ticket, a scratch-off lottery ticket, or free parking passes. In some examples, a display of the PCD may display a machine readable indicia (e.g., barcode) that can be rapidly scanned and read by a reader device.

In some embodiments, a loitering reward may be provided to the customer in the form of reward points (e.g., frequent flyer miles), discounts, or store credit. Other incentives could be rewards given to customers who visit and loiter repeatedly over days, weeks, months or years, and/or visit and loiter at multiple locations.

In some examples, the definition message (A) may define more than one region. In some examples, the defined regions may be contiguous, such as adjacent departments within a retail store. In some other examples, two or more regions may not be contiguous, such as two coffee shops. In some examples, the regions may be defined in terms of latitude and longitude, and/or relative to a reference location (e.g., a cellular telephone tower).

In some examples, the definition message (A) may define more than one duration. For example, the defined duration may include a first duration in a first zone, and a second duration in a second zone that is different than the first zone. In some examples, one region may be associated with a first duration and a first reward, and further associated with a second duration and a second reward that is different than the first reward. Accordingly, longer durations may receive enhanced rewards. In other embodiments, durations beyond a threshold duration may receive declining rewards, for example, to incentivize at least a minimum loitering time while also incentivizing a maximum loitering time.

In some embodiments, a retailer may establish an incentive program with a predetermined reward structure based on the duration of stay, either alone or in combination with other parameters. For example, differentiated rewards may be offered for loitering for at least a predetermined duration on specific days of the week, month, or year, for example. As an illustration, a retail store may offer enhanced reward for loitering a predetermined duration before noon on a selected holiday. By communicating promotional offers on a targeted day, or during a specified portion of a selected day, a retailer may attract interested shoppers who may generate increased revenue.

In some embodiments, retailers may offer differentiated awards based on the duration of time spent in a target region within a second period of time. For example, a retailer may offer an enhanced reward to a customer who is determined to be in the loitering space for at least a minimum threshold of minutes each week, month, year, or other specified time period.

In some examples, retailers may offer further enhanced rewards based on loitering time in the loitering space in combination with one or more additional criteria. One exemplary additional criterion may be reaching a threshold number of visits to one or more specified loitering spaces.

Another exemplary criterion for enhanced rewards may include reaching a threshold number (e.g., at least one) visits of a specified duration to each of a number of different zones within the retail location. For example, one enhanced reward criterion may be to spend a predetermined time (e.g., at least 10 minutes) in each of 5 zones of the retail store. Each zone may be defined according to the boundaries of a department or an area of similar-type products (e.g., office supplies, home furnishings, men's clothes, women's clothes, children's clothes, sporting goods, groceries). In some examples, verification of presence within a zone may be verified using short range techniques. For example, Wifi antennas in the store may be used to more accurately and reliably determine a location of the customer within a particular zone in the store. Wifi enabled mobile devices may advantageously be monitored as they are moved throughout an array of WiFi stations, and the location may be determined, for example, by triangulation. Some or all of these techniques may be supplemented or replaced with other techniques for locating the user's position within one of the zones in the store. Such techniques may include, but are not limited to monitoring an accelerometer in the mobile device, for example.

Another exemplary criterion for enhanced rewards may include reaching a threshold number of visits of at least a predetermined time duration to one or more additional loitering zones. In some implementations, a retail store may wish to incentivize customers to spend time in other locations. In some examples, two retail locations may collaborate and coordinate their marketing efforts by offering enhanced rewards for individuals who visit both locations. Two, three, four, or any predetermined number more different establishments may be entered as optional loitering sites in the incentive system. In an example, a user may receive a special bonus reward when the incentive system records that the user has loitered for the required duration at six of ten available related loitering sites.

By way of example, not limitation, various embodiments of the incentive system could be advantageously implemented by stores, malls, casinos, amusement parks, auditoriums, entertainment centers, bars, coffee shops, or restaurants to attract individuals to dwell at a certain geographic location for a predetermined time period.

In an illustrative example, a retailer (e.g., a fast food restaurant) may offer an embodiment of the incentive system to track the duration of stay of a movie goer (e.g., 90 minutes) at a movie theatre, in order to target certain discounts to actual movie goers.

In another illustrative example, a consumer, upon purchasing shampoo at a drugstore, receives an offer providing that if the consumer stays in the store for an additional 15 minutes, he will receive a reward in the form of an electronic coupon valid for free or discounted conditioner that can then be used immediately. Any previous information gleaned about a consumer, which may be received from a third party or the retailer, for example, may be aggregated with information pertaining to the offer and the user already stored in records of the loitering engine. The loitering engine may aggregate the information to determine a more optimal incentive reward for the consumer based on predetermined criteria specified by the retailer, for example.

In another example, a consumer may accept an offer to loiter in a drug store. The consumer may surf the Internet on his smartphone while browsing at the drugstore, and information about the surfing preferences may used to determine an appropriate reward.

In some examples, two or more PCD users may receive offers that require the parties to meet and loiter for at least a predetermined time at a predetermined location in order to receive a reward. Each of the parties may be identified by a member of the party in some examples via submission of contact information stored in the user's PCD. In some implementations, one or more parties may be strangers matched according to a common interest (e.g., in a sports event viewing). The incentive system may mediate the location by selecting and proposing a list of suitable locations, such as a retail store (e.g., bookstore, coffee shop, restaurant, amusement park) that are substantially equidistant from, and/or between, each party's current location. In some embodiments, credit for the time requirement begins to accrue after all parties who have accepted the offer have arrived at the location. In some embodiments, the rate of credit toward the durational requirement accrues according to the number of accepting parties who are currently maintaining their presence at the location. When the durational requirement is met, the loitering engine may cause a reward to be generated to each of the accepting parties. The incentive system may issue bonus rewards for the first to arrive, the longest duration, and the last to leave, for example.

In another embodiment, an incentive reward system may provide the retailer (goods or services provider) with a dashboard on a retail client display device. The dashboard may provide one or more measurements of the success or failure of a particular reward. A dashboard window display could show the retailer which rewards are most successful in enticing a particular consumer, or the average consumer, to maintain a presence. The dashboard may also serve as a means for communicating customers' earned rewards to the retailer in order to improve efficiency of reward redemption or avoid fraudulent claims by customers.

In various examples, the reward notification and other messages may be communicated from the incentive system to the user via text message, multimedia message, automated voice mail notification, and/or e-mail. In some examples, the message to the user may contain a link to a web page or PCD software application with a full description of the message and related information, such as user notices, legal information, user account and contact information.

In various examples, the location of the PCD may be tracked using wireless techniques (e.g., signal strength and/or direction relative to one or more antennae of known positions) for determining the location of a portable communication device. In some embodiments, the PCD may further include an accelerometer. The system may monitor location of the PCD based on motion data from the built-in accelerometer, alone or in combination with at least one other location technique. For example, the location of the PCD may be determined at a relatively high repetition rate based on motion information derived from the accelerometer, and any position offset errors may be periodically corrected based on a second location signal that is received at a relatively low repetition rate. By way of example, the relatively low repetition rate may repeat every about 0.5, 1, 2, 5, 10, 15, 20, 25, 30, 35, 40, 45, 50, 55, 60, 65, 70, 75, 80, 85, 90, 95, 100, 120, 150, 180, 240, or at least about 300 seconds. The relatively high repetition rate may repeat at a substantially higher rate than the effective low repetition rate. In some implementations, the second location signal may be derived as an estimate of the position of the PCD based on signal strength and location as received by or from a wireless antenna or a set of antennae. In some implementations, an offset correction signal may be derived from an operation such as user confirmation of presence at a defined location, or scanning by a bar code or radio frequency identification scanner or reader, for example. In some implementations, location of the PCD may be determined, at least in part, by location services modules that use short range wireless radio capacitive coupling between devices. In some embodiments, more than one method or algorithm may be used to determine and/or correct information indicating a location of a PCD. Examples of techniques that may be used in a location service module to locate a PCD may include, but are not limited to instant photography or video with recognition capabilities, or wifi with IP address monitoring.

Some embodiments may include a smartphone-mediated loyalty reward program whereby persons may receive rewards for visiting, and optionally returning to, and loitering or lingering for defined periods of time in a particular geographically defined area.

According to an exemplary embodiment of the disclosed incentive system, a woman sees an online advertisement for a series of free lottery-style sweepstakes games, which customers can enter by loitering in participating establishments for certain time periods, as verified through the customers' smart phones. As instructed by the commercial, the woman downloads a software application into her mobile phone, opens the application, and enters basic registration information such as her name and home address. The application determines the woman's location using cell tower triangulation technology and lists several nearby establishments participating in the promotional games. The application informs the woman of several lottery-style sweepstakes games that will be held that day, each with its own odds of winning, prizes, location and loitering duration requirement. The woman reviews the options and proceeds to a local participating coffee shop, where she can enter into a lotto-style sweepstakes for a chance to win a new motorboat by remaining for ten minutes. She reopens the application, which determines her presence by means of cell tower triangulation technology. The smartphone displays a game board containing 42 available numbers. She presses a virtual “quick pick” button to have six of the 42 numbers automatically selected for her by the application, and taps a virtual “submit” button. The application re-verifies the woman's presence and displays a timer that begins counting down ten minutes. The woman orders and receives a cup of coffee and, two minutes later, takes a call on her smartphone lasting one minute, which time is counted toward the ten minute requirement. The countdown still in progress, she orders a second cup of coffee. Once the ten minutes have elapsed, the application informs the woman that her entry into the sweepstakes has been validated. She leaves the coffee shop and returns home. Later that evening, a drawing is held, and the woman opens the application to discover that she did not match any winning numbers. Determined to be a winner, she opens the application to see whether any additional sweepstakes games are available to be played that night. She may consider, for example, entry into a game of skill or a game of chance, such as a game that may be sponsored by a national fast-food restaurant franchise. She discovers that if she spends an hour at a local shopping mall (as verified by her smartphone), she will earn a virtual “scratch-off” lottery-style ticket entitling her to a percentage discount ranging from 10% to 50% on a single purchase during her next visit to the mall. She goes to the mall and, after activating the application and spending over an hour purchasing several new clothing outfits, receives the virtual ticket on her phone. She rubs her finger on the screen of her smartphone to virtually “scratch off” the ticket and discovers that she has won a 25% discount on any purchase in that mall, valid on her next visit.

According to another exemplary embodiment of the disclosed incentive system, a customer walks in the front door of a discount superstore seeking a can of shaving cream. Near the entrance, he notices an easel board advertising a free lotto-style sweepstakes game. Upon closer inspection, he discovers that he may enter the game by remaining in the store for twenty minutes, as verified by his smartphone. As instructed, he installs and opens a software application on his smartphone. The application verifies his presence in the store using GPS technology. As prompted by the application, he then enters six lucky numbers (out of 54 numbers available) and taps a virtual “submit” button. A timer displaying “20:00” (representing the twenty minutes) appears on his smartphone and immediately begins counting down. The customer grabs a handheld cart and begins wandering around the store, filling the cart with miscellaneous goods to be purchased. Four minutes later, the customer's smartphone rings, and he takes a call lasting three minutes, which time the application does not count toward the twenty minute requirement. A server connected to the application through a mobile data network “pings” the application every minute, tracking and recording the customer's movement around the store, noting especially the extended period the customer remains in the children's toy department. Once the customer has remained in the store for twenty minutes, the application displays a message notifying the customer of his entry into the sweepstakes. The customer then completes his purchases and leaves the store. Later the same evening, a drawing is held in which six winning numbers are selected from 54 available numbers. After the drawing, the customer reopens the application, which informs him that three of the winning numbers were among the ones that he had previously selected, making him a winner. Several weeks later, he receives a $1.00 prize check in the mail, along with a coupon for a discount on children's toys (targeted based on the customer's movement within the store). Excited about the potential for winning more money, the customer returns to the store and tries to “cheat” the system by activating the application, hiding his phone on a store shelf behind some cans of dog food, and going across the street for pizza and beer. When he returns to retrieve his phone, he is dismayed to find that he was not entered into that day's sweepstakes because the application detected through the smartphone's accelerometer that the phone had remained perfectly still during the prescribed time period.

According to a further exemplary embodiment of the disclosed incentive system, an entrepreneur named Peter opens a new nightclub in town. To promote the club during the first week after its opening, Peter offers free admission and one free drink to each new patron. During that week, hundreds of groups of patrons visit the nightclub, but each leaves quickly after arriving and consuming the free beverages, because at any particular time not enough other patrons are at the nightclub to make the experience of being at the nightclub worthwhile as compared to other popular nightclubs. The nightclub quickly establishes a reputation of being “dead.” Peter then decides to offer a smartphone-based incentive system whereby the consumer at the night club is required to wait a set time period, but this requirement decreases as the number of users in the conditional area increases. If a threshold number of customers is exceeded, then all users present and currently loitering to meet the durational requirement may be absolved from the durational requirement and receive a reward incentive. In some examples, the loitering engine may be configured with instructions to dynamically discontinue or suspend publication of the offer for the nightclub, for example, at least until the night club has additional available capacity. Accordingly, the loitering engine may receive current available capacity status information from the retail client. In some examples, the loitering engine may be configured with instructions to withdraw offers with respect to users not yet present in the conditional area of the night club.

As an illustrative example, a patron named Enzo opens a bar tab at 9:00 p.m. and settles in for a fun-filled Friday night. At 2:00 a.m. the bar stops serving drinks, but because the nightclub's owner wishes to mitigate any risk of liability that might arise from acts of intoxicated patrons, it stays open until 4 a.m. for dancing so such patrons may sober up before leaving. Enzo, who is an awkward dancer and would prefer to leave the bar while still intoxicated than be embarrassed in front of his colleagues on the dance floor, receives a countdown on his phone that encourages him to remain in the nightclub for a couple hours in exchange for a coupon code valid for free admission to the nightclub on his next visit.

According to a further exemplary embodiment of the disclosed incentive system, a city may use an embodiment of the system to influence crowd movements (e.g., just before the ball drops on New Years Eve).

According to a further exemplary embodiment of the disclosed incentive system, a live television audience is incentivized by a reward (e.g., an opportunity to play a keno-style sweepstakes game) to stay and watch the entire show. Time for filming to end is undetermined at the beginning. In some examples, the amount of rewards may be based on how much of the audience has remained present throughout the show.

According to a further exemplary embodiment of the disclosed incentive system, a number of fans wait in the cold for tickets the night before a hit musical. The first 30 people in line receive a free ticket. The incentive system identifies the first thirty people with the incentive system application on their mobile devices in line, and a reward may be provided by way of the incentive system application on their mobile phones.

According to a further exemplary embodiment of the disclosed incentive system, some embodiments of the incentive system may be used a form of crowd control. As one example, at a theme park, the user may be rewarded for every minute they spend at less crowded areas of the park. If one end of the park is crowded, the incentive system may offer rewards (e.g., discount foods, retail items, line jumping privileges) for time spent loitering in other areas of the park or in retail gift shops located within the park.

According to a further exemplary embodiment of the disclosed incentive system, a customer Jerry visits the Clothing Store with his friend Steven. They walk in and see a sign that advertises a free lottery-style game reward smartphone program. Jerry downloads the application and runs it on his smartphone. The countdown timer for a 120 minute duration requirement begins counting down. At this time the program pushes a notification that informs Jerry that the requirement will decrease by one minute for every friend from his smartphone address book who downloads the application. As a result, Jerry persuades his friend Steven to download the application and register for the program. In some implementations, when they both use the application in the same geographic location in the same time period, an additional benefit of shortening of the required waiting time for both parties may be offered. As a further example, Jerry and Steven may be given the ability to share one common set of numbers for entry into the lottery-style game, and split any associated winnings.

Various implementations may be implemented on a server in communication with one or more clients. The clients may include applications running on mobile communication devices (e.g., smart phones), portable computers (e.g., laptops, notebooks, tablet computers), and/or retail access nodes. The clients and server may communicate electronic messages by way of one or more communication links, which may include one or more segments that may be wired, optical, and/or wireless. The communications may be formatted using any suitable modulation or encoding scheme for the various segments and links of the network. For example, some wireless communication may be by way of WiFi, WiMax, 4G, 3G, 2G, cellular, Bluetooth, wireless local area network, wide area networks alone or in combination with one or more short and/or long range techniques.

Network interfaces may encompass communication networks such as local-area networks (LAN) and wide-area networks (WAN). LAN technologies include Fiber Distributed Data Interface (FDDI), Copper Distributed Data Interface (CDDI), Ethernet/IEEE 1102.3, Token Ring/IEEE 1102.5 and the like. WAN technologies may include, but are not limited to, point-to-point links, circuit switching networks like Integrated Services Digital Networks (ISDN) and variations thereon, packet switching networks, and Digital Subscriber Lines (DSL).

Some communication segments may be transported with a wired or wireless network, such as an intranet, local area network, extranet, or the Internet. Some communications may be encrypted for security.

Some implementations may be controlled in response to signals from analog or digital components, which may be discrete, integrated, or a combination of each. Some embodiments may include programmed and/or programmable devices (e.g., PLAs, PLDs, ASICs, microcontroller, microprocessor, digital signal processor (DSP)), and may include one or more data stores (e.g., cell, register, block, page) that provide single or multi-level digital data storage capability, and which may be volatile and/or non-volatile. Some control functions may be implemented in hardware, software, firmware, or a combination of any of them.

Computer program products may contain a set of instructions that, when executed by a processor device, cause the processor to perform prescribed functions. These functions may be performed in conjunction with controlled devices in operable communication with the processor. Computer program products, which may include software, may be stored in a data store tangibly embedded on a storage medium, such as an electronic, magnetic, or rotating storage device, and may be fixed or removable (e.g., hard disk, floppy disk, thumb drive, CD, DVD).

In some implementations, a computer program product may contain instructions that, when executed by a processor, cause the processor to determine whether a personal communication device is within a predetermined region for at least a predetermined duration of time.

Some embodiments may be implemented in a computer system. For example, various embodiments may include digital and/or analog circuitry, computer hardware, firmware, software, or combinations thereof. Apparatus can be implemented in a computer program product tangibly embodied in an information carrier, e.g., in a machine-readable storage device, for execution by a programmable processor; and methods can be performed by a programmable processor executing a program of instructions to perform functions by operating on input data and generating an output. Various embodiments may be implemented advantageously in one or more computer programs that are executable on a programmable system including at least one programmable processor coupled to receive data and instructions from, and to transmit data and instructions to, a data storage system, at least one input device, and/or at least one output device. A computer program is a set of instructions that can be used, directly or indirectly, in a computer to perform a certain activity or bring about a certain result. A computer program can be written in any form of programming language, including compiled or interpreted languages, and it can be deployed in any form, including as a stand-alone program or as a module, component, subroutine, or other unit suitable for use in a computing environment.

Suitable processors for the execution of a program of instructions include, by way of example, both general and special purpose microprocessors, which may include a single processor or one of multiple processors of any kind of computer. Generally, a processor will receive instructions and data from a read-only memory or a random access memory or both. The essential elements of a computer are a processor for executing instructions and one or more memories for storing instructions and data. Generally, a computer will also include, or be operatively coupled to communicate with, one or more mass storage devices for storing data files; such devices include magnetic disks, such as internal hard disks and removable disks; magneto-optical disks; and optical disks. Storage devices suitable for tangibly embodying computer program instructions and data include all forms of non-volatile memory, including, by way of example, semiconductor memory devices, such as EPROM, EEPROM, and flash memory devices; magnetic disks, such as internal hard disks and removable disks; magneto-optical disks; and, CD-ROM and DVD-ROM disks. The processor and the memory can be supplemented by, or incorporated in, ASICs (application-specific integrated circuits).

In some embodiments, one or more user-interface features may be custom configured to perform specific functions. Some examples may be implemented in a computer system that includes a graphical user interface and/or an Internet browser. To provide for interaction with a user, some embodiments may be implemented on a computer having a display device, such as a CRT (cathode ray tube) or LCD (liquid crystal display) monitor for displaying information to the user, a keyboard, and a pointing device, such as a mouse or a trackball by which the user can provide input to the computer.

In various embodiments, the user terminal, such as a user terminal coupled to the retail client 115 or the PCD 130a, may communicate using suitable communication methods, equipment, and techniques. For example, the vendor may send or receive messages over a bus and/or using point-to-point communication in which a message is transported directly from the source to the receiver over a dedicated physical link (e.g., fiber optic link, point-to-point wiring, and daisy-chain). The components of the system may exchange information by any form or medium of analog or digital data communication, including packet-based messages on a communication network. Examples of communication networks include, e.g., a LAN (local area network), a WAN (wide area network), MAN (metropolitan area network), wireless and/or optical networks, and the computers and networks forming the Internet. Other embodiments may transport messages by broadcasting to all or substantially all devices that are coupled together by a communication network, for example, by using omnidirectional radio frequency (RF) signals. Still other embodiments may transport messages characterized by high directivity, such as RF signals transmitted using directional (i.e., narrow beam) antennas or infrared signals that may optionally be used with focusing optics. Still other embodiments are possible using appropriate interfaces and protocols such as, by way of example and not intended to be limiting, USB 2.0, Firewire, ATA/IDE, RS-232, RS-422, RS-485, 802.11a/b/g, Wi-Fi, Ethernet, IrDA, FDDI (fiber distributed data interface), token-ring networks, or multiplexing techniques based on frequency, time, or code division. Some implementations may optionally incorporate features such as error checking and correction (ECC) for data integrity, or security measures, such as encryption (e.g., WEP) and password protection.

A number of implementations have been described. Nevertheless, it will be understood that various modification may be made. For example, advantageous results may be achieved if the steps of the disclosed techniques were performed in a different sequence, or if components of the disclosed systems were combined in a different manner, or if the components were supplemented with other components. Accordingly, other implementations are within the scope of the following claims.

What is claimed is:

1. A system that facilitates rewards for an individual who carries a portable communication device (PCD) upon maintaining a presence in a predetermined region, the system comprising:
a data store; and,
a processor operably coupled to a program storage device to receive instructions stored in the program storage device, wherein when the processor executes the received instructions, the processor performs the following operations:
(a) receive offer information that identifies a predetermined geographical region associated with an offer to incentivize an individual carrying a PCD to maintain a presence within the predetermined geographical region, wherein the offer information further identifies a required loitering time duration associated with the offer;
(b) store the offer information in the data store;
(c) receive a first signal indicating a presence of the PCD within the predetermined geographical region at a first time;
(d) receive a second signal indicating the presence of the PCD within the predetermined region at a second time that is at least the required loitering time duration after the first time; and
(e) generate an electronic reward notification message in response to receiving the second signal.

2. A computer program product (CPP) tangibly embodied in a computer readable medium and containing instructions that, when executed on a processor, cause the processor to performs operations to incentivize a portable communication device (PCD) user to maintain a presence in a selected area for a minimum time duration, the operations comprising:
(a) receive first information that identifies a predetermined geographical region associated with an offer to incentivize an individual carrying a PCD to maintain a presence within the predetermined geographical region;
(b) receive second information that identifies a required loitering time associated with the offer;
(c) receive third information that identifies a portable communication device (PCD);
(d) associate the third information with the offer and store the association in a data store;
(e) receive a first signal indicating the detection of the presence of the PCD within the predetermined region at a first time, wherein detecting the presence of the PCD includes receiving information to locate the PCD by way of a first wireless communication link;
(f) receive a second signal indicating the presence of the PCD within the predetermined region at a second time that is at least the required loitering time after the first time; and
(g) in response to the second signal, generate an electronic reward notification message for transmission by way of a second wireless link to the PCD.
